(19) United States
(12) Patent Application Publication
(10) Pub. No.: US 2012/0066765 A1
(43) Pub. Date: Mar. 15, 2012

(54) System and method for improving security using intelligent base storage

(76) Inventor: John O'Brien, Short Hills, NJ (US)

(21) Appl. No.: 13/199,413

(22) Filed: Aug. 29, 2011

Related U.S. Application Data
(60) Provisional application No. 61/403,023, filed on Sep. 10, 2010.

(51) Int. Cl. G06F 11/00; G08B 23/00

(52) U.S. Cl. 726/23

(57) ABSTRACT

The present invention presents a system and method for providing improved security within a computer system by using an intelligent based storage system operating with the host unit whereby, the intelligent based storage system independently provides monitoring of files that should not be accessed, monitoring of files that should be accesses with strict regularity, and analysis of access patterns.

### PRIORITY INFORMATION

This application claims priority of U.S. provisional application Ser. No. 61/403,023, filed 10 Sep., 2010, entitled, “System and Method for Improving Security Using Intelligent Based Storage”.

### FIELD OF THE INVENTION

The present invention relates generally to the field of computer environments. More specifically, in networked, virtual, and distributed computer environments, a method for improving security using intelligent based storage.

### BACKGROUND

Computer systems, networks, configurations, systems, software, and protocols are all vulnerable to attack from unauthorized sources. These attacks may represent amateur behavior, up to sophisticated and coordinated attempts to subvert the privacy and security of the individual, organization, company, or state. Automated tools as well as the ubiquity of network interfaces, and connections make it easier for unauthorized sources to attack.

Once discovered, the vulnerability results are often posted on the web where subsequent attacks—using the posted techniques—then become more widespread.

As cloud computing becomes more of a reality, systems become more interconnected and distributed and more data is stored on different networked servers, creating more points of potential attack.

As virtual computing becomes more popular, if attackers can penetrate the core of a virtual machine, they can compromise security in the plurality of machines, sometimes as many as fifty different partitions, that are apportioned from that virtual machine.

Indeed an entire industry comprising: access control; virus identification, isolation and containment; firewall control and management; and data protection has grown in response to these threats. In addition, some practiced techniques sometimes called “honeypots” (Levy U.S. Pat. No. 7,725,937) or “tarpits” (Purcell U.S. patent application 0080235769) bait attackers by offering monitored attackable locations. If an attacker tries to access such a monitored network point, a response is engaged to determine if the system is under attack.

Smith (Smith U.S. patent application 0080216175) discusses techniques to “taint” data whereby the metadata associated with the data carries a taint status indicating the data itself is tainted or has once been stored in a tainted location.

### SUMMARY OF THE INVENTION

It is the object of the present invention to provide an improved system and method for improving security for a computer system by using intelligent based data storage together with the native host intelligence.

Prior art security defenses focus on network protection and breaches. The security concern is to put up a wall around the metaphoric computer system castle and keep attackers on the other side of that wall.

After breaches occur, prior art security then relies on analysis programs that use sophisticated techniques to recognize—and repair—viruses, worms, and similar evidence of post attack infiltrations.

The present invention assigns a new role, one of active security, to the data storage unit, and relies on the intelligence in that data storage unit to help improve security, in real time, by working in preordained ways with one or more connected host computers.

The new security role (“Security Role”) assigned to the data storage unit embodies at least one of the following three specific behaviors: (1) to monitor that specific storage locations are never accessed—similar to honeypot/tarpit function except that the focus is applied to data storage locations and not network addresses, (2) to monitor that specific storage locations are accessed within prescribed timeframes, (3) to analyze usage patterns and draw tentative conclusions. These roles are described below in more detail.

For clarity, a data storage unit (“Data Storage Unit”) is a system or device which either has onboard storage media or manages attached storage media of some type, and which contains a processor, memory, command interface, and an ability to execute computational instructions. By this definition, an intelligent Network Attached Storage (NAS) server as well as an off-the-shelf SCSI drive meet the definition, although neither of those two Data Storage Units would be considered to be practicing the present invention unless they were running specific code to perform at least one of the Roles of the present invention.

FIG. 1A depicts a Data Storage Unit 101 functional view. Within the Data Storage Unit, is the storage media 102 which typically is at least one data storage drive, but which may be any storage media such as non volatile RAM, or solid state drives, optical drives, etc.

A preferred embodiment for the Data Storage Unit would be a NAS server. Typical components, CPU 104, memory 107, command interface 106, facilitate a program execution capability, 103. External communication capability 105 allows at will communication to external networks.

In an embodiment of the present invention, a predefined set of access and or non-access policies is first decided upon, or selected from a set of different optional default conditions and these selections together define operational policies (“Operational Policies”). Together, at least one host processor acts out the access/non-access scenario with at least one Data Storage Unit. Potential security breaches correspond to the transgressing of any pre-defined policy, and details on these potential breaches are communicated in real time to one or more monitoring end points.

A preferred embodiment of the present invention is one where the Data Storage Unit has an ability to initiate communications over some type of communications channel, so that reporting of potential security breaches are simplified. However, the inventors recognize that the definition above of the Data Storage Unit does not specifically include initiating communications, as the intention was to include less restrictions for the Data Storage Unit, recognizing that various embodiments of the present invention could be practiced quite well in an environment where one or more Data Storage Units was polled for its monitoring results.

In summary of this point, the inventors state that having an ability to initiate communications at will is an desirable but not necessary requirement to practice the present invention. The inventors further recognize that embodiments of the present invention include an embodiment where all Data Storage Units have an ability to initiate communications; an embodiment were no Data Storage Units have an ability to initiate communications; and an embodiment where some Data Storage Units have an ability to initiate communications, and other Data Storage Units do not.

### BRIEF DESCRIPTION OF THE DRAWINGS

The features and advantages of the present invention will become apparent to those skilled in the art from the following description with reference to the drawings, in which:

FIG. 1A shows a diagram of a Data Storage Unit.

FIG. 1B shows the interaction between a host unit, a Data Storage Unit, and an alarm end point.

FIG. 2 shows a state diagram over time of the operation of the present invention.

### DETAILED DESCRIPTION OF INVENTION AND THE PREFERRED EMBODIMENTS

One major aspect of the present invention is an ability of the Data Storage Unit to execute some monitoring and analysis roles. Let's define those three roles, mentioned above, in greater detail at this point.

Role to monitor that specific storage locations are not accessed. In similar fashion to deploying honeypot addresses across a network, the present invention uses specific storage locations or file names where it does not expect access at all, or it expects only controlled access. For convenience we refer to either the specific storage location to be monitored, or the specific file to be monitored as simply the honeypot file (“Honeypot File”). (“Controlled Access”) is defined as one or more predefined access patterns around the Honeypot File, so that the Honeypot File could then be accessed without generating an alarm. Some examples: this pattern might involve accessing the same Honeypot File name with a different extension either immediately before or after; (2) performing multiple successive READS of the same Honeypot File; (3) access using a specific user id; (4) varying the time of access to a specific window; or (5) any mix or combination of these examples. These selections are included into the Operational Policies of the Data Storage Unit relative to the corresponding host unit. Those skilled in the art will recognize that there are hundreds of such variations, and similar steps to use. We have listed our preferred embodiments of these patterns and they should not be read as a limitation on the present invention.

In the context of a file server, once received, the Honeypot Files are located stored and managed by the Data Storage Unit. These files are managed, in appearance, just as regular and system files. In order to look real, these files would be assigned tag along attributes (“Tag Along Attributes”) of other files meaning that when the associated file is accessed, an algorithm would be executed to update the access metadata record of the Honeypot file. In this way sometimes Honeypot attributes would be, according to the algorithm, sometimes updated, sometimes not, sometimes identical to the associated file, sometimes a week or two backwards in time. These selections are included into the Operational Policies of the Data Storage Unit relative to the corresponding host unit. Thus the Honeypot files would appear to be within the range of expected usage for system files, and not identifiable by an attacker. Since the intelligence doing this updating and monitoring takes place only within the Data Storage Unit, there is no way for an attacker present on the host processor to understand what the defense is.

A period of definition and initialization is required to first establish this role. During that time, a system administrator defines specific file names which are declared to be Honeypot files by an administrative selection using the Data Storage Unit control software; these selections are included into the Operational Policies of the Data Storage Unit relative to the corresponding host unit. From that point forward there is no indication whatsoever on the host that any Honeypot File is different. An actual READ command from the host will result in this original contents of the Honeypot file being sent to the host processor as if it were a normal transfer. A WRITE from the host will write to the Honeypot File. However, from the time of any access request, excepting a Controlled Access request, of any Honeypot File, alarm data is collected and sent to at least one alarm end point.

An alarm end point, (“Alarm End Point”) designates one or more receptor sites for alarm data being reported by the Data Storage Unit. Often this will result in a call to a phone or mobile phone, email, or text message. The exact end point depends on the nature of the threat attack and the intention of the system administrator. The system administrator can define one or more end points using the Data Storage Unit control software. Nothing in this specification should limit the type or range of the Alarm End Point. The inventors recognize that different system requirements may need a display on a monitor, or an audible alarm, or for input to a computer program, or to a teletype machine, or to any combination of the examples provided in this paragraph, or imagined, and there are no limitations on what an end point may be or where it might be located.

Role to monitor that specific storage locations are accessed within prescribed timeframes. A second and independent defense against attack, is a requirement for the host processor to access a different set of monitored files, called Honeypot2 files. (“Honeypot2 Files”) Honeypot2 Files use the same selection, and definition, and Controlled Access, approach as Honeypot Files, and Honeypot2 Files are also monitored by the Data Storage Unit, but instead of not having an access, it is expected that the host processor would access Honeypot2 files within some agreed upon time window established in the definition phase as part of the Operational Policies. The system administrator can select or enter a timeframe, using Data Storage Unit control software, on a file by file basis. These selections are included into the Operational Policies of the Data Storage Unit relative to the corresponding host unit. If a file is not accessed during the prescribed time window, then alarm data is sent to the Alarm End Point. Note that the an agreed upon time window, (“Agreed Upon Time Window”) is not limited to a periodic window, like every hour, or once a week, but may mean some defined period such as the second ten minute period after every hour, or some rotating time window revolving around the clock, such as, for example, within 0 to 5 minutes after 12:00, or within 5:01 to 10:00 minutes after 1:00, . . . or within 55:01 to 59:59 minutes after 11:00, or some such variation.

Role to analyze usage patterns. A third and independent defense against attack, is an analysis of usage patterns. If significant computational capability is present in the Data Storage Unit, suggesting that the Data Storage Unit is a NAS or server based unit and not a less capable SCSI drive, the role of monitoring and analyzing usage patterns may be invoked. Three types of analysis usage patterns are included here, user access, process access, and temporal access.

Analysis software which tracks user access patterns, (User Access Patterns) such as time of access, duration of access, points of access, content accessed, and READ/WRITE usage, is available to be run on the Data Storage Unit. If specific users exhibit User Access Patterns that statistically exceed a system administrator defined threshold compared with their standard User Access Patterns, then alarm data is sent to the Alarm End Point.

Analysis software which tracks user process patterns, (Process Access Patterns) such as which fonts, libraries, databases, and shared libraries are accessed prior to, in conjunction with, or after an executable program. If specific users exhibit Process Access Patterns that statistically exceed a system administrator defined threshold compared with their standard User Access Patterns, then alarm data is sent to the Alarm End Point.

As an additional usage analysis, temporal access, system administrators can define time periods for ‘no access’ zones or ‘limited access’ zone on a user by user basis. Specifically this might be, for example 2 to 5 AM, or Sundays, or outside user shift periods, just as examples. Access in such periods would generate either an alarm or warning message to the Alarm End Point.

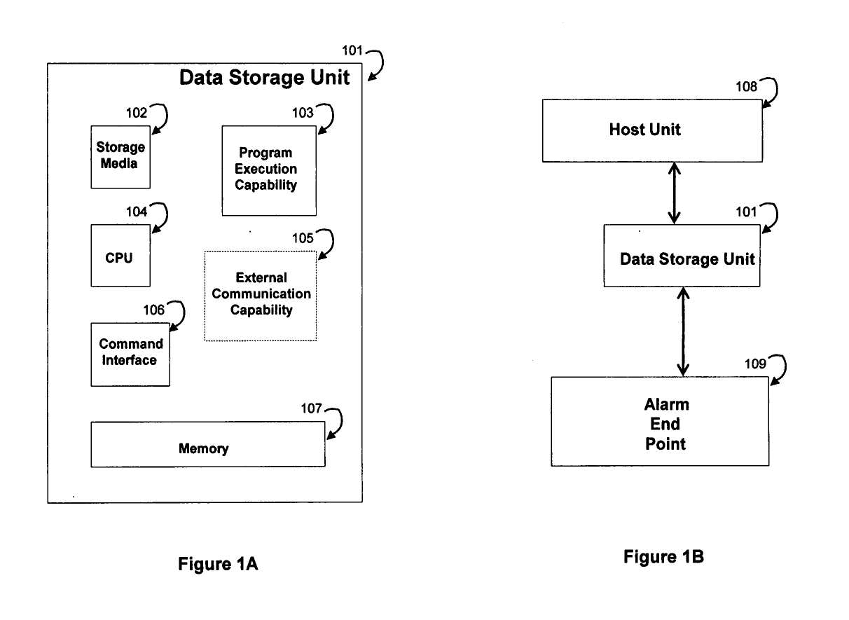

FIG. 1B presents a high level view of the present invention. Data Storage Unit 101 services one or more requests from at least one host unit 108 in the normal manner. In an additional Security Role, Data Storage Unit 101 also monitors one or more Security Roles defined above. If an alarm condition is reached, Data Storage Unit 101 sends the alarm data to at least one Alarm End Point 109. Note that there may be many different Alarm End Points each corresponding to a specific host unit from among a plurality of host units.

The Alarm End Point is the controlling mechanism of how to respond to the alarm condition. The alarm data, sent to the Alarm End Point should help in that decision. The alarm condition can be: cleared, ignored, monitored, or the Alarm End Point can directly initiate a lockdown mode to the Data Storage Unit. In lock down, the Data Storage Unit would service no requests from the offending host unit, and would respond to those requests using a standard answer defined by the system administrator using Data Storage Unit control software during installation; this response is part of the Operational Policies.

Note that FIG. 1B shows no explicit communication link between host unit 108 and Alarm End Point 109. The present invention, as a preferred embodiment, does not rely on such a link because a compromised host presents security issues if it can influence alarm decisions at the Alarm End Point. However such a concern should not be read as a limitation on the specification of the present invention and some implementers may even choose to collocate the Alarm End Point in the host unit for some purposes.

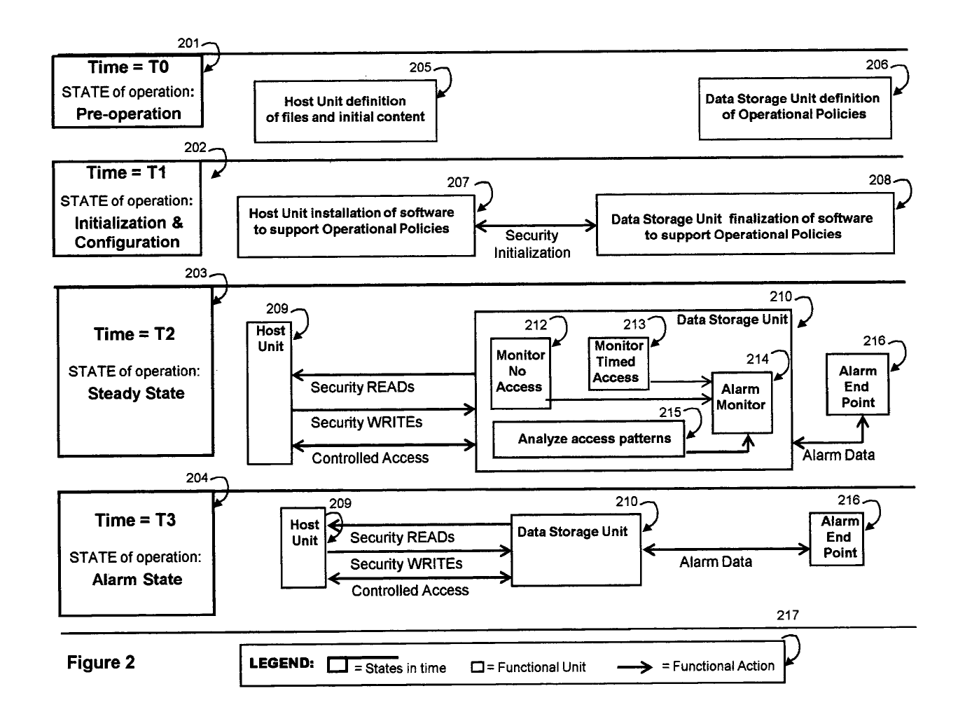

FIG. 2 presents a view of the present invention at different time intervals, or states. In order to describe the present invention four states are considered and each state is represented in FIG. 2 as a horizontal band: Pre-operation 201, Initialization & Configuration 202, Steady State 203, and Alarm State 204. The legend 217 shows the designation for states, as well as within the different states, functional units or operations represented by a box outline, and functional action, represented by the arrows between functional units. Consider each state in more detail below.

The Pre-operation 201 state is a period where definition of which of the Security Roles, discussed above to define the Operational Policies 206, are to be invoked and which parameters are to be associated with them. The administrative selections are made using a control program which executes on the Data Storage Unit 206. This program, which is simple input software to select file names and operational parameters to be used in monitoring, is not the subject of the present invention, and the preferred embodiment of that program is a GUI (Graphical User Interface) program. The inventors realize that such a program could be located anywhere as long as the program had READ and WRITE access so that it could read file names and also store the system administrator's selections on the Data Storage Unit. As a preferred embodiment we have chosen location on the Data Storage Unit.

Some definition needs to occur on the host unit side 205, but such definition falls with the normal usage of the host like creating the Honeypot File or Honeypot2 Files to be monitored. For example: when a system administrator registers a Honeypot2 file on the Data Storage Unit by using the Data Storage Unit control software, to be periodically read, that file must first have been created by the host unit and stored on the Data System Unit. Likewise a process would need to be created to execute on the host unit and access the required Honeypot2 file according to the definition rules defined by the storage administrator using the Data Storage Unit control software. Similarly, before selecting a Honeypot File to be monitored for no access, that file must have first been created using the host unit.

The Initialization & Configuration 202 state concerns the first access by the host unit of the Data Storage Unit for the monitored files. Monitored files may be altered at any time using the Controlled Access method described above; this would be an example of configuring or re-configuring the files to be monitored. It is during this state that any process required on the host unit 207 to access Honeypot2 Files are installed and tested. Operational parameters for file monitoring defined and selected need to be made as a final selection on the Data Storage Unit 208.

The Steady State 203 state is the normal operation of the system. Host unit 209 and Data Storage Unit 210 operate in the normal way to process IO. In addition, security READs or WRITEs to satisfy any system administrator selected Honeypot2 File monitoring 213 must occur in the Agreed Upon Time Window as specified by the system administrator during states T0, 201 and T2, 202. Similarly, the Data System Unit will perform system administrator selected monitoring 212 for any Honeypot Files to insure that there is no access. Likewise, if the system administrator selected access monitoring 215 it would be performed by the monitoring software in the Data Storage Unit as well. Note that the system administrator could optionally select some or all of these Security Roles.

The Alarm State 204 is entered if any selected Security Role meets the criteria for an alarm condition. If so, the software running that Security Role would notify the alarm monitor 214, during state T2 and the alarm monitor would format the associated data and send the alerts to one or more Alarm End Points 216, moving the system to state T3. During state T3 normal IO operation continues between host unit 209 and Data Storage Unit 210 unless otherwise directed by action from the Alarm End Point 216 and discussed above in the Alarm End Point discussion.

During states T2 and T3 Security READs and WRITES of Honeypot2 Files should occur as needed consistent with normal IO. In addition, Controlled Access may also occur to Honeypot Files and Honeypot2 Files as discussed above in the Controlled Access discussion.

Nothing in this specification should be understood to limit the present invention to the required use of a specific NAS unit, or of a NAS unit in general. The inventors note that a preferred embodiment of the present invention has a NAS unit as the Data Storage Unit. However, the inventors recognize that an embodiment of the present invention could be configured using a SCSI drive with modified driver as the Data Storage Unit.

In summary, the present invention presents a system and method for providing improved security within a computer system by using an attached intelligent based storage system operating with the host unit whereby, the intelligent based storage system independently provides one or more of the following: (i) monitoring of files which should not be accessed, (ii) monitoring of files which should be accesses with strict regularity, and (iii) analysis of access patterns.

1. A method for providing improved security within a computer system with a Network Attached File System, comprising the steps of:
a. defining Operational Policies to be used between at least one host unit and one or more Data Storage Units;
b. initializing first operation of the files to be monitored;
c. performing IO in the normal way between at least one host unit and at least one Data Storage Unit;
d. monitoring predefined Honeypot Files to insure they are not accessed as defined and to generate an alarm condition if accessed; and
e. responding to alarm conditions by notifying one or more Alarm End Points.

2. A method for providing improved security within a computer system with a Network Attached File System, comprising the steps of
a. defining Operational Policies to be used between at least one host unit and one or more Data Storage Units;
b. initializing first operation of the files to be monitored;
c. performing IO in the normal way and any predefined security READs or WRITES, between at least one host unit and at least one Data Storage Unit;
d. monitoring predefined Honeypot2 Files to insure they are accessed as regularly as defined and to generate an alarm condition if not; and
e. responding to alarm conditions by notifying one or more Alarm End Points.
